(19) United States
(12) Patent Application Publication
(10) Pub. No.: US 2003/0127118 A1
(43) Pub. Date: Jul. 10, 2003

(54) CLEANING GAS

(76) Inventor: MITSUSHI ITANO, OSAKA (JP)

Correspondence Address: LARSON & TAYLOR, PLC, 1199 NORTH FAIRFAX STREET, SUITE 900, ALEXANDRIA, VA, 22314, US

(21) Appl. No.: 09/214,708

(22) PCT Filed: Jul. 9, 1997
(86) PCT No.: PCT/JP97/02369

(30) Foreign Application Priority Data
Jul. 10, 1996 (JP) 180518/1996

(51) Int. Cl. B08B 7/04; B08B 3/00

(52) U.S. Cl. 134/37

(57) ABSTRACT

The present invention provides a chamber cleaning gas for Si film, SiO₂ film, Si₃N₄ film or high-melting metal silicite film, the gas comprising at least one gas selected from the group consisting of CF₃CF═CF₂,

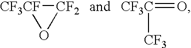

and provides a chamber cleaning method.

### TECHNICAL FIELD

The present invention relates to a cleaning gas suitable for use in production of semiconductors.

### BACKGROUND ART

Perfluoro compounds such as CF₄, C₂F₆, C₄F₈ (perfluorocyclobutane) and SF₆ are used in large amounts as cleaning gases for plasma CVD chambers in production of semiconductors. Since the perfluoro compounds are stable and have long atomospheric lifetimes and high infrared absorbency, they have extremely high global warming potential (GWP) as compared with carbonic acid gas. CF₄ is 6300 times, C₂F₆ is 1250 times, C₄F₈ is 9100 times and SF₆ is 24900 times as high as carbonic acid gas in GWP. Therefore, development of a substitute gas having a low global warming potential is an urgent task.

An object of this invention is to provide a substitute gas which is suitable for use as a cleaning gas for plasma CVD chambers in production of semiconductors, the gas having a low global warming effect.

### DISCLOSURE OF INVENTION

The present invention provides the following cleaning gas and cleaning method:

1. A chamber cleaning gas comprising at least one gas selected from the group consisting of CF₃CF═CF₂,

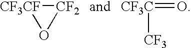

2. A chamber cleaning method comprising cleaning a plasma CVD chamber of a semiconductor integrated circuit production device using at least one gas selected from the group consisting of

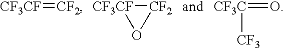

As the chamber cleaning gas of the invention, any of

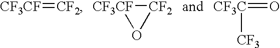

can be used; they can be used singly or in combination of two or more. The chamber cleaning gas of the invention may be used in combination with a monomer gas such as He, Ne, Ar, H₂, N₂ or O₂.

There is no limitation on materials of the chamber. The chamber may be made of known materials such as stainless steel or aluminum alloy. Without adversely affecting the materials of the chamber, the chamber cleaning gas of the invention can quickly remove reaction byproducts attached to the wall of the chamber.

Examples of byproducts removed by the cleaning method of the invention are silicon, polysilicon, tungsten, titanium and their oxides, nitrides and carbides.

As the chamber cleaning conditions of the invention, conventional conditions using perfluoro compounds may be used as they are.

All the three kinds of chamber cleaning gases of the invention have satisfactory levels of properties so that they can be used as substitutes for conventionally used chamber cleaning gasses, namely, CF₄, C₂F₆ and SF₆. Moreover, the gases of the invention have much lower global warming potential than CF₄, C₂F₆ and SF₆.

For example, when used under known chamber cleaning conditions (pressure=100 m Torr; input high-frequency power=300 W; gas flow rate=50 cc/min) for 30 minutes, CF₃CF═CF₂ of the invention fully and quickly removes attached byproducts from the chamber without damaging the chamber. Thus CF₃CF═CF₂ of the invention is suitable for use in practice.

When

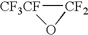

is used in place of CF₃CF═CF₂ under the above conditions,

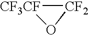

fully and quickly removes attached byproducts from the chamber without damaging the chamber, thus being usable in practice.

Similarly, when

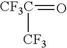

is used in place of CF₃CF═CF₂,

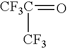

fully and quickly removes attached byproducts from the chamber without damaging the chamber, thus being usable in practice.

According to the present invention, chamber cleaning can be done satisfactorily, without using any of CF₄, C₂F₆, C₄F₈ and SF₆ that have extremely high global warming potential as compared with carbonic acid gas.

1. A chamber cleaning gas comprising at least one gas selected from the group consisting of CF₃CF═CF₂,

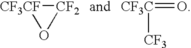

2. A chamber cleaning gas according to claim 1 comprising CF₃CF═CF₂.

3. A chamber cleaning gas according to claim 1 comprising hexafluoropropylene oxide represented by the formula

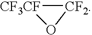

4. A chamber cleaning gas according to claim 1 comprising CF₃COCF₃.

5. A chamber cleaning gas according to any one of claims 1-4 which further comprises at least one monomer gas selected from the group consisting of He, Ne, Ar, H₂, N₂ and O₂.

6. A chamber cleaning method comprising the step of treating a plasma CVD chamber of a semiconductor integrated circuit production device with at least one chamber cleaning gas selected from the group consisting of CF₃CF═CF₂,

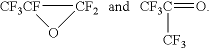

7. A chamber cleaning method according to claim 6 wherein the chamber cleaning gas is CF₃CF═CF₂.

8. A chamber cleaning method according to claim 6 wherein the chamber cleaning gas is hexafluoropropylene oxide represented by the formula

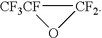

9. A chamber cleaning method according to claim 6 wherein the chamber cleaning gas is CF₃COCF₃.

10. A chamber cleaning gas according to any one of claims 6-9 which further comprises at least one monomer gas selected from the group consisting of He, Ne, Ar, H₂, N₂ and O₂.
